(19) United States
(12) Patent Application Publication
(10) Pub. No.: US 2012/0316874 A1
(43) Pub. Date: Dec. 13, 2012

(54) RADIOLOGY VERIFICATION SYSTEM AND METHOD

(76) Inventor: Brian T. Lipman, Hartland, WI (US)

(21) Appl. No.: 13/444,580

(22) Filed: Apr. 11, 2012

Related U.S. Application Data
(60) Provisional application No. 61/475,025, filed on Apr. 13, 2011.

(51) Int. Cl. G10L 15/26

(52) U.S. Cl. 704/235; 704/E15.043

(57) ABSTRACT

A system and method of radiology verification is provided. The verification may be implemented as a standalone software utility, as part of a radiology imaging graphical user interface, or within a more complex computing system configured for generating radiology reports.

### FIELD OF THE INVENTION

The present invention relates generally to systems and methods for verifying radiology reports. More particularly, the invention relates to a system and method of using voice recognition software to identify missing keywords in a radiology report.

### BACKGROUND OF THE INVENTION

Most radiologists review digitized radiology images with use of a computer display, as electronic versions of the radiology images are rendered in a software graphical user interface (GUI) operating on a computer system. Radiologists often use voice recognition software that interfaces with the graphical user interface to dictate interpretations of the radiology images in an expeditious manner. The use of a voice recognition dictation system allows observations of the radiology images to be quickly dictated by the radiologist into the computer system, as a written report is immediately generated from the dictation for use by the medical facility or physician treating the patient.

Radiologists are often under time constraints to produce an accurate yet complete reading of the radiology images, particularly in emergency or time-sensitive settings. Despite the electronic advancements in various imaging devices, radiology image viewers, and software GUI enhancements—the report produced by the radiologist is ultimately dependent on human judgment. Techniques are needed to improve the efficiency and accuracy of radiology report generation, and assist radiologists with generating more accurate and complete reports.

### BRIEF SUMMARY OF THE INVENTION

The present disclosure describes a number of verification techniques related to the generation and use of radiology reports. These verification techniques may be implemented as a standalone software utility, as part of a radiology imaging graphical user interface, or within a more complex computing system configured for generating radiology reports.

As one example of an embodiment of the present invention, a radiologist may dictate his or her observations about the radiology images into a computing system using voice recognition software. While the voice recognition software recognizes natural language words from an audio source, the natural language words may be provided as text in the radiology imaging graphical user interface as a report is created. During and after the creation of the report in the radiology imaging GUI, the verification process may operate to check for the existence of certain words, terms, phrases, or natural language concepts. The verification process can then prompt the radiologist to provide dictation or a textual description of the key anatomical structures or physiological conditions that are missing from the radiology report.

With use of the techniques described herein, the accuracy and completeness of the produced radiology report may significantly increase. Further, implementation of the verification techniques into existing radiology imaging GUIs and radiology work flows enables increased accuracy and completeness with minimal radiologist time and effort.

### BRIEF DESCRIPTION OF THE DRAWINGS

FIG. 1 provides an overview of one exemplary embodiment of a computing system configured for displaying radiological images and performing radiology reporting verification in accordance with the present invention; and

FIG. 2 provides a flowchart of one exemplary embodiment of a radiology reporting verification process in accordance with the present invention.

### DETAILED DESCRIPTION OF THE INVENTION

One embodiment of the present invention provides a series of verification techniques and methods to ensure that a radiology report contains a complete description. These verification techniques may be run against the radiology report during and after the read by the radiologist to ensure that the report does not lack a description for important anatomical or physiological features. As one example, when a radiologist dictates a radiological report, there are key anatomic structures (such as organs, bones, tissue) that he or she should comment on. The verification techniques described herein check for mention of these structures and prompt the radiologist as necessary to provide details on the structures. The various prompts and suggestions presented to the radiologist may be customized based on radiologist preferences, the type of radiological scan procedure, or the type of medical procedure or suspected medical diagnosis.

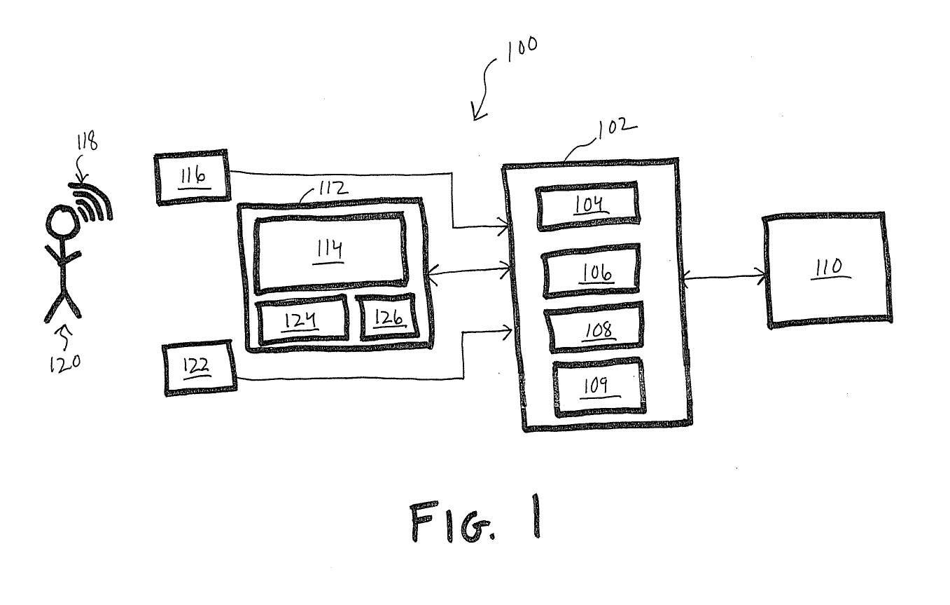

FIG. 1 provides an overview of a computing system 100 configured for displaying radiological images and performing radiology reporting verification in accordance with an embodiment of the present invention. As illustrated in FIG. 1, the computing system 100 generally includes a computer case 102 having processing means 104, memory containing voice recognition software 106, memory containing radiology reporting software 108, and one or more data locations 109. Alternatively or in addition, the computing system 100 may communicate with one or more remote/external data locations 110. Operably connected to the computer case 102 is a display 112 for displaying images 114, a microphone 116 for detecting and transmitting voice commands 118 from a user 120, and a manual input device 122 such as a mouse or keyboard for enabling the input of manual commands by the user 120. The display 112 may also be configured to display a dictated radiology report 124 and a list of keywords 126 that are missing from the report.

As an example of the verification process of the present invention, after dictating or otherwise creating the radiology read report via the microphone 116 or manual input device 122, a check may be performed against the report to determine if key structures were omitted or discussed within the report. If key structures were not commented on, then these structures (based on the keywords 126) could be listed on the side of the report 124 to allow easy selection or insertion into the report before the radiologist signs off on it. The radiologist may also be presented with an additional opportunity to review the images with attention to the structures that he or she did not mention. The verification may serve as both a safety precaution and as a completeness check for the produced report.

The verification process is intended to fully address the most serious situation where the radiologist omits a key anatomic structure in the report, suggesting that he or she did not carefully examine the structure and its physiological operation. Alternatively the radiologist may have evaluated the anatomic structure but simply forgot to mention it in the report, or the radiologist may not have provided a full or understandable description of the structure in the report. Performing real-time verification of the report therefore enables both improved accuracy and completeness of the report.

In one embodiment, the verification is performed by the radiology reporting software commands 108 which search a dictated report to detect missing keywords. This check may be performed on the results of either a voice recognized/dictated or typed report.

In one embodiment, different sets of keywords may be automatically selected based on the identified/selected exam type. For example, in a CAT scan of the abdomen and pelvis, the liver, gall bladder, spleen, adrenal glands, kidneys, pancreas, aorta, urinary bladder, and osseous structures are all key anatomical structures that should be referenced in the report. If the radiology procedure is a chest xray, then pneumothorax, heart size, and lymphadenopathy are all physiological conditions that should be mentioned.

Alternatively or additionally, there may also be a list of keywords that the radiologist manually selects for comparison to his or her radiology report. The check may occur in real time with the output provided by the voice recognition software 106 or by other textual input checking. The list of keywords may be configured to be displayed either while the radiologist is dictating the report, or immediately after the radiologist hits a display dictated text option for the report.

The verification process may operate in a way to enable the radiologist to have the opportunity to review the report while the images are still available or displayed. If the radiologist notices particular highlighted structures that he or she forgot to comment on, the radiologist could be provided with options to easily review the images again, edit the report, and complete work on the case.

The list of keywords may be provided to the radiology reporting software 108 using any of a number of suitable data locations 109, including a customized dictionary, a database, XML file, or another data store. Customized lists of keywords may also be stored in a data store according to the radiologist user preferences or the type of radiological imaging procedure performed.

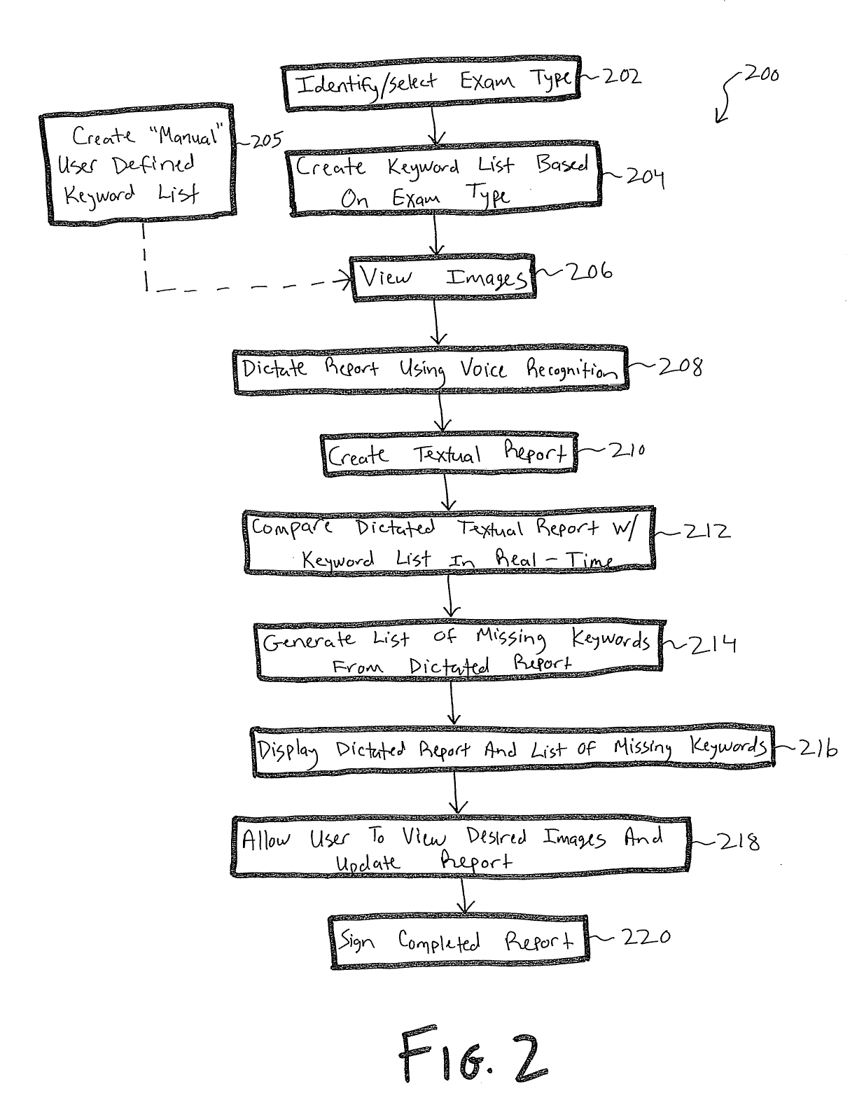

FIG. 2 provides a flowchart of one exemplary radiology reporting verification process 200 in accordance with the present invention. The process 200 begins at step 202 where the radiologist identifies or selects an exam to be interpreted. Then, in step 204, a keyword list is generated based on the identified or selected exam type that includes a compilation of each and every keyword that should be found in a radiology report for that exam type. As illustrated in FIG. 2, the process may alternatively begin by “manually” creating a customized, user defined list of keywords at step 205 that the radiologist expects should be found in the radiology report.

Regardless of whether the process 200 begins with steps 202/204 or step 205, it continues with the radiologist viewing the images at step 206 and dictating the radiology report using voice recognition at step 208. Next, the computing system creates a textual report based on the detected voice commands in step 210. Subsequently, in step 212 the dictated textual report is compared with the keyword list from step 204 (or step 205) in real time. A list of missing keywords from the dictated textual report is then generated in step 214.

The process 200 continues at step 216 where the dictated textual report and the list of missing keywords are displayed to the radiologist. In step 218, the radiologist is allowed to select and display desired images in order to update the radiology report in view of the missing keywords. Once the radiologist is satisfied with the report and all missing keywords have been addressed, the radiologist signs the completed report at step 220 and the process is complete.

Although several exemplary steps were described with reference to the radiology reporting verification process 200, those skilled in the art will appreciate that the order and number of steps may be modified without departing from the intended scope of the present invention. Thus, the exemplary steps were provided merely for purposes of example and not limitation.

Those skilled in the art will also recognize that the verification and information processing techniques described herein are also applicable to other medical fields beyond radiology, and in particular to other medical imaging and health information processing disciplines (such as pathology, medical records, and the like). Further, the accuracy techniques described herein may be adapted to a variety of other information processing disciplines where a report is generated and produced by a human.

The various components of the present invention may be embodied exclusively as or in combination with a system, method, device, or computer program product. Accordingly, the various aspects of the present invention may be embodied in any combination of hardware or software aspects. Furthermore, the presently described invention may include a computer program product embodied in any non-transitory, tangible medium of expression having computer usable program code embodied in the medium.

Computer program code for carrying out operations of the present invention may be written in any combination of one or more programming languages, including an object oriented programming language such as C++, C#, Java, Smalltalk or the like and conventional procedural programming languages, such as “C” or similar procedural programming languages. The program code may execute on processors or other hardware contained entirely on a user's computer, partly on a user's computer, as a stand-alone software package, partly on a user's computer and partly on a remote computer, entirely on the remote computer or server, and/or in a virtualized or cloud computing environment. Remote computers may be connected to a user's computer through any type of network, including a local area network (LAN), a wide area network (WAN), a secure virtual private network (VPN) or intranet, or the connection may be made to an external computer (for example, through the Internet using an Internet Service Provider).

Although various representative embodiments of this invention have been described above with a certain degree of particularity, those skilled in the art could make numerous alterations to the disclosed embodiments without departing from the spirit or scope of the inventive subject matter set forth.

What is claimed is:

1. A method for the verification of radiology reporting with use of a radiology processing system, comprising:
selecting an patient examination report to be verified;
providing a database in communication with a microprocessor, said database including a compilation of keywords based on the selected examination report;
viewing images related to the patient examination report;
dictating the radiology report into said database using voice recognition;
translating the voice recognition into detected voice commands;
creating a textual report based on the detected voice commands;
comparing the textual report with the compilation of keywords to generate a listing of missing keywords in the textual report;
displaying the textual report and missing keywords to a radiologist user;
selecting and displaying desired images to update the textual report based on the missing keywords;
finalizing the report.
